(19) United States
(12) Patent Application Publication
(10) Pub. No.: US 2023/0231447 A1
(43) Pub. Date: Jul. 20, 2023

(54) ELECTRICAL POWER CONVERSION APPARATUS

(71) Applicant: Mitsubishi Electric Corporation, Tokyo (JP)

(72) Inventor: Koichi KOINUMA, Tokyo (JP)

(73) Assignee: Mitsubishi Electric Corporation, Tokyo (JP)

(21) Appl. No.: 18/080,116

(22) Filed: Dec. 13, 2022

(30) Foreign Application Priority Data
Jan. 17, 2022 (JP) 2022-004807

(51) Int. Cl. H02K 11/25; H02K 11/35; G05D 23/19

(52) U.S. Cl. CPC H02K 11/25; H02K 11/35; G05D 23/1932

(57) ABSTRACT

An electrical power conversion apparatus is obtained which can accurately estimate a temperature of a rotating machine when a state of its cooling device for cooling it changes, and reliably carry out its protective operation, so that its failure to be brought about because of its high temperature state can be prevented. A control device of the apparatus comprises: a rotating machine losses calculator for calculating losses of the rotating machine by using its output status; a cooling-device state estimation device for estimating a state of the cooling device from a temperature detection value of a temperature detector for detecting a temperature of the rotating machine; and a rotating machine temperature calculation device for estimating a temperature at a predetermined position of the rotating machine, based on a rotating machine's losses calculation value of the rotating machine losses calculator and an estimation result of the cooling-device state estimation device.

### BACKGROUND OF THE INVENTION

### Field of the Invention

The disclosure of the present application relates to an electrical power conversion apparatus.

### Description of the Related Art

An electric automotive vehicle such as an electric motor vehicle and a hybrid motor vehicle has an electric motor(s) for use in drive motions and/or an electric power generator(s) for use in electric power production. In such a rotating machine described above, its permanent magnets are buried mainly in a rotor, and its windings provided for its stator are placed in slot portions of the stator. In addition, such a rotating machine described above is controlled by means of an electrical power conversion apparatus mounted on the electric automotive vehicle.

As for an electrical power conversion apparatus intended for use in an electric automotive vehicle and a rotating machine(s) intended therefor, it is required for them to operate without causing their malfunction or failure under various conditions, and also to continue their operations without causing their hard-stopping situations for the sake of securing the safety of the automotive vehicle at a time when their abnormality occurs. For dealing therewith, the electrical power conversion apparatus is provided with a protective function(s) for avoiding a malfunction or failure of a rotating machine(s) by monitoring a status of the rotating machine(s) and by controlling the operations of the rotating machine(s) in accordance with the status.

In windings, electrical steel plates or sheets, permanent magnets and the like each constituting a rotating machine, losses of the rotating machine such as ohmic or copper loss and/or iron loss are caused according to driving the rotating machine and/or to electric power generation thereby, so that the respective component constituting the rotating machine liberates heat. In general, a rotating machine is cooled by means of a cooler or a cooling device; however, in such a case that the rotating machine deviates from a predetermined operating range having been defined in advance and/or a case that abnormality occurs in the cooling device, there exists a possibility that the rotating machine results in a malfunction or failure due to its overheating. Among the components constituting a rotating machine, the components for which their careful considerations are particularly required against a high temperature are windings and a permanent magnet(s). When the windings undergo a high temperature, they may give rise to their burn-damage, causing an earth-leakage. In addition, as for the permanent magnet(s), its irreversible demagnetization is caused when the rotating machine is operated at a time of its high temperature.

Generally speaking, in order to prevent burn-damage of a winding(s), a temperature detection of the winding(s) is performed by means of a temperature detector, so that, when a temperature detection value thereby reaches at a predetermined temperature defined in advance or more, an electrical power conversion apparatus carries out a protective operation by which the operations of a rotating machine is halted. Meanwhile, because a permanent magnet(s) is buried in a rotor, it is difficult to directly perform the temperature detection. In addition, in order to reduce iron loss, the permanent magnet(s) buried in the rotor is divided into pieces, so that their divided faces exert difficulty in transferring heat therethrough, and, because of this, a temperature of the permanent magnet(s) is not uniform, but the temperature thereof has a temperature distribution. For this reason, even when a special mechanism is provided for the rotor and when a temperature of the permanent magnet(s) is directly detected, it is not a sufficient measure to carry out a protective operation by using the detection value. For these reasons, it is general implementation to estimate a temperature of the permanent magnet(s), and so, when the estimation temperature reaches at a predetermined temperature defined in advance or more, the electrical power conversion apparatus carries out a protective operation.

As a scheme for estimating a temperature of a rotating machine, there is a scheme for estimating a temperature of a permanent magnet by using a thermal equivalent circuit based on relationships among a temperature(s), the amount of heat liberated, and thermal resistance (for example, refer to Patent Document 1).

[Patent Document 1] Japanese Patent Laid-Open No. 2008-245486

According to a scheme disclosed in Patent Document 1, a temperature of a permanent magnet is estimated by using a thermal equivalent circuit utilizing specified thermal resistance; meanwhile, changes in a state of a cooling device are not taken into consideration in the temperature estimation. For example, in rotating machines for use in an electric automotive vehicle, coolers or cooling devices are frequently used in each of which a fluid is utilized as a cooling medium; however, in such a case, it is necessary to presume the leakage of cooling water and/or that of cooling oil as an abnormal state(s) in the environment. Depending on the presence or absence of the cooling water and/or the cooling oil, spreading of heat of the cooling device and that of the rotating machine are changed, so that the specified thermal resistance described above also changes. That is to say, in a case in which a state of the cooling device changes, there arises a problem in that a temperature of the permanent magnet cannot be accurately estimated.

### SUMMARY OF THE INVENTION

The present disclosure of the application concerned has been directed at solving those problems as described above, and an object of the disclosure is to provide an electrical power conversion apparatus in which, by determining a state of a cooling device for cooling a rotating machine, a temperature of the rotating machine can be accurately estimated even when a state of the cooling device changes, and thus, a protective operation to the rotating machine is reliably carried out, so that a malfunction or failure of the rotating machine to be brought about because of its high temperature state can be prevented.

In an electrical power conversion apparatus disclosed in the present disclosure of the application concerned, the electrical power conversion apparatus comprises:
a control device for controlling a rotating machine cooled by a cooling device; and
a temperature detector for detecting a temperature of the rotating machine, wherein
the control device comprises:
   a rotating machine losses calculator for calculating losses of the rotating machine by using an output status of the rotating machine;
   a cooling-device state estimation device for estimating a state of the cooling device from a temperature detection value of the temperature detector; and
   a rotating machine temperature calculation device for estimating a temperature at a position of the rotating machine determined in advance, on the basis of a rotating machine's losses calculation value of the rotating machine losses calculator and on that of an estimation result of the cooling-device state estimation device.

According to the electrical power conversion apparatus disclosed in the disclosure of the application concerned, it is possible to accurately estimate a temperature of a rotating machine by determining a state of a cooling device even when a state of the cooling device changes, and thus, a protective operation to the rotating machine is reliably carried out, so that it becomes possible to prevent a malfunction or failure of the rotating machine to be brought about because of its high temperature state.

### BRIEF DESCRIPTION OF DRAWINGS

FIG. 1 is a diagram illustrating a thermal network in a rotating machine controlled by an electrical power conversion apparatus according to Embodiment 1;

FIG. 2 is a schematic configuration diagram illustrating a configuration of the electrical power conversion apparatus according to Embodiment 1;

FIG. 3 is a diagram illustrating a configuration of a control device in the electrical power conversion apparatus according to Embodiment 1;

FIG. 4 is a diagram illustrating a configuration of a cooling-device state estimation device in the electrical power conversion apparatus according to Embodiment 1;

FIG. 5 is a diagram illustrating a configuration of a rotating machine temperature calculation device in the electrical power conversion apparatus according to Embodiment 1; and

FIG. 6 is a diagram showing a hardware configuration of the control device in the electrical power conversion apparatus according to Embodiment 1.

### DETAILED DESCRIPTION OF THE PREFERRED EMBODIMENTS

Hereinafter, the explanation will be made referring to the drawings for exemplary embodiments of an electrical power conversion apparatus according to the embodiments; however, in each of the figures, the same reference numerals and symbols designate the same or equivalent items or portions, and thus their explanation redundant thereto is omitted.

### Embodiment 1

First, the explanation will be made for a rotating machine controlled by the electrical power conversion apparatus according to Embodiment 1.

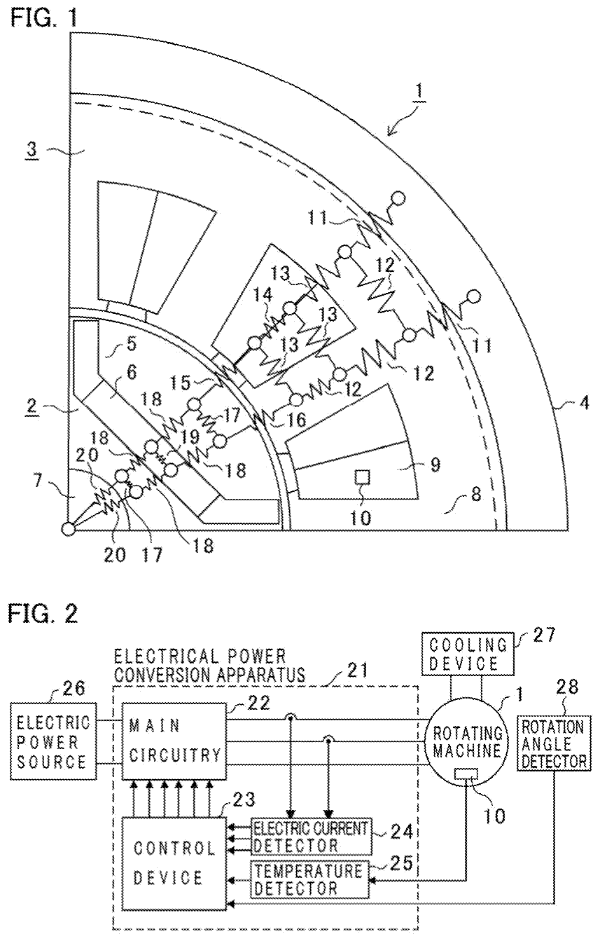

FIG. 1 is a diagram illustrating a thermal network between a cooling device and a rotating machine in an example of the rotating machine which uses the cooling device. Referring to FIG. 1, the explanation will be made for changes in a correlation between thermal resistance or electrical losses and increase of the temperature, i.e., a temperature rise, according to the changes in a state of the cooling device.

As illustrated in FIG. 1, the aforementioned rotating machine 1 is constituted of a rotor 2 and a stator 3, and a housing 4. The rotor 2 includes rotor's electrical steel plates or sheets 5, permanent magnets 6, and a shaft 7; and the stator 3 includes stator's electrical steel plates or sheets 8, and windings 9. On the outer lateral side of the stator 3, the housing 4 is mounted; and, formed between the stator 3 and the housing 4 is a water flow-path (also referred to as a “cooling medium flow-path,” which is appropriately shown by the broken lines) through which cooling water being a cooling medium for use in the cooling flows, whereby the water flow-path constitutes a portion of the cooling device for cooling the stator 3. As for the cooling medium, for example, cooling oil may also be suitably used for, other than the aforementioned cooling water. A temperature sensor 10 is mounted on the winding(s) 9 as an example; however, the temperature sensor may be mounted on the stator's electrical steel sheet(s) 8, the permanent magnet(s) 6, the shaft 7, the housing 4 and the like, and those temperatures at a plurality of positions may also be detected.

A thermal network is configured by heat transfer paths constituted of thermal resistance 11 between the cooling device and the stator's electrical steel sheets 8, thermal resistance 12 within the stator's electrical steel sheets 8, thermal resistance 13 between the stator's electrical steel sheets 8 and windings 9, thermal resistance 14 within the windings 9, thermal resistance 15 between the windings 9 and an air gap, thermal resistance 16 between the stator's electrical steel sheets 8 and the air gap, thermal resistance 17 within the rotor's electrical steel sheets 5, thermal resistance 18 between the rotor's electrical steel sheets 5 and the permanent magnets 6, thermal resistance 19 within the permanent magnets 6, thermal resistance 20 between the rotor's electrical steel sheets 5 and the shaft 7, and so forth.

Here, when a state of a cooling device is normal, increase of the temperature, i.e., a temperature rise, in accordance with a loss(es) caused by the rotating machine 1 is given by means of the thermal network described above, by taking on a temperature of cooling water in the cooling device as a reference. Because of this, a temperature of the permanent magnet(s) 6, a temperature detection value of a temperature detector utilizing the temperature sensor 10 and a temperature of the cooling water are uniquely determined. Therefore, by defining the thermal network described above as a known one, a temperature of the permanent magnet(s) 6 can be estimated by means of a detection temperature of the temperature detector utilizing the temperature sensor 10.

However, in a case of the leakage of cooling water as an example of a change in a state of a cooling device, the cooling water results in nonexistence, and thus, heat liberation paths through into the cooling water are lost, so that the thermal resistance 11 between the cooling device and the stator's electrical steel sheets 8 in the aforementioned thermal network becomes high to a large extent. In FIG. 1, the thermal network is described only by those pieces of thermal resistance for brevity of explanation; however, under actual circumstances, each piece of thermal resistance has in parallel therewith thermal capacitance and thermal flow-rate. A temperature of the permanent magnet(s) 6 and a detection temperature by means of the temperature sensor 10 each take on transient temperature transition in which thermal capacitance is predominant, and in which a temperature distribution where cooling water is lost is defined as an initial state.

As described above, when a state of a cooling device changes, the thermal network changes, and, for this reason, the relationship between a permanent magnet's temperature and a detection temperature of the temperature detector changes. When the relationship therebetween changes, a temperature of the permanent magnet(s) 6 cannot be estimated in good accuracy, so that it is feared that irreversible demagnetization of the permanent magnet(s) 6 may be brought about.

FIG. 2 is a schematic configuration diagram illustrating the configuration of the electrical power conversion apparatus according to Embodiment 1. As illustrated in FIG. 2, the electrical power conversion apparatus 21 comprises main circuitry 22, a control device 23, an electric current detector 24 and a temperature detector 25. To the electrical power conversion apparatus 21, an electric power source 26 and the rotating machine 1 are connected. Here, it is presumed that the rotating machine 1 takes on a similar configuration to FIG. 1 described above; however, a kind of the rotating machine 1 is not necessarily limited to this. For example, the rotating machine may also be an induction machine or a direct current (DC) machine. In addition, the temperature sensor 10 in FIG. 1 is mounted on the winding(s) 9 as an example; however, the temperature sensor may be mounted on the stator's electrical steel sheet(s) 8, the permanent magnet(s) 6, the shaft 7, the housing 4 and the like, and those temperatures at a plurality of positions may also be detected. Moreover, a cooler or a cooling device 27 mounted on the rotating machine 1 is not necessarily limited to a water-cooling cooling device, but an oil-cooling cooling device may also be suitable for.

When a case is presumed in which the rotating machine 1 is a permanent magnet synchronous motor operated by alternating-current (AC) power, DC power supplied from the electric power source 26 is converted into AC power according to fundamental operations of the electrical power conversion apparatus 21, which outputs the AC power into the permanent magnet synchronous motor being the rotating machine 1. In order to control the rotating machine 1 at its arbitrary outputs, the electrical power conversion apparatus 21 produces switching signals by using an output instruction value(s) in the control device 23, an electric current value acquired from the electric current detector 24, and a rotation angle acquired from a rotation angle detector 28. The switching signals are inputted into the main circuitry 22, and arbitrary AC power is produced from the DC power in accordance with the switching signals for performing the turn-on/turn-off control on switching devices constituting the main circuitry 22, so that the permanent magnet synchronous motor being the rotating machine 1 is controlled. Here, in a case in which the rotating machine 1 is an electric power generator, the flow of the electric power is reversed in its direction, so that electric power produced by means of the rotating machine 1 is converted in electric power by means of the electrical power conversion apparatus 21, and the electric power being converted is outputted into the electric power source 26. As for electric power conversion in a case in which the rotating machine 1 is a direct current (DC) machine, a DC voltage outputted from the electric power source 26 or that outputted from the DC machine being the rotating machine 1 is performed on boost conversion or buck conversion in voltage, which is inputted into the DC machine being the rotating machine 1 or into the electric power source 26, respectively.

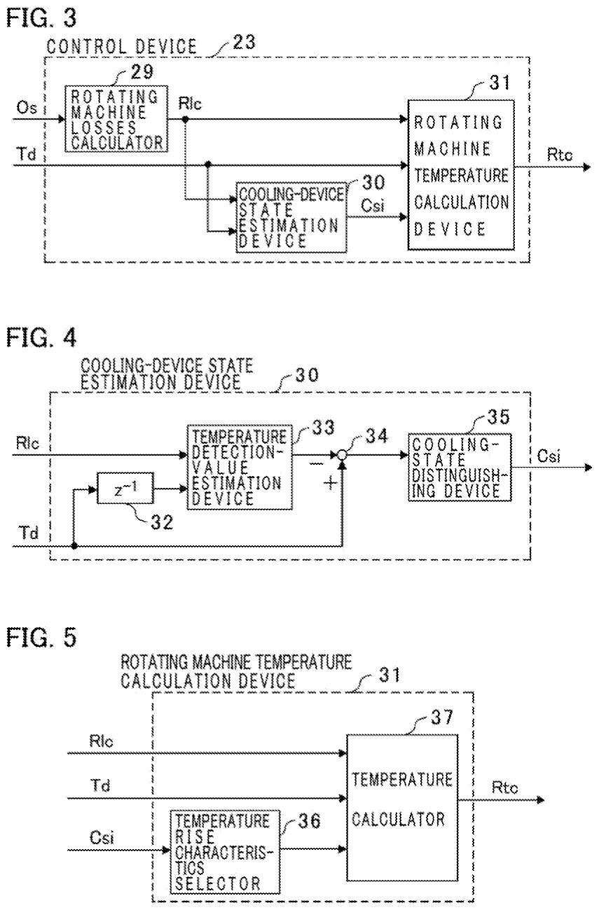

FIG. 3 is a block diagram illustrating a configuration of the control device 23 of the electrical power conversion apparatus 21. As illustrated in FIG. 3, the control device 23 comprises: a rotating machine losses calculation-unit or calculator 29 receiving as its input an output status Os of the rotating machine 1, for calculating losses of the rotating machine 1; a cooling-device state estimation device 30 receiving as its inputs a rotating machine's losses calculation value Rlc and a temperature detection value Td by means of the temperature detector 25, for estimating a state of the cooling device 27; and a rotating machine temperature calculation device 31 receiving as its inputs cooling-device state information Csi outputted from the cooling-device state estimation device 30, the rotating machine's losses calculation value Rlc and the temperature detection value Td, for calculating a temperature at a predetermined position of the rotating machine 1 having been defined in advance.

The rotating machine losses calculator 29 calculates an ohmic or copper loss, and an iron loss. The copper loss is the loss caused in the windings 9 where Joule heat is produced in the windings when an electric current energizes through them. Meanwhile, the iron loss is the loss caused in electrical steel plates or sheets and in the permanent magnets 6 both being magnetic materials, and can be mainly divided into eddy current loss and hysteresis loss in a broad manner. The eddy current loss is caused by eddy currents flowing in a magnetic material. The hysteresis loss is caused due to hysteresis characteristics of the magnetic material. The rotating machine losses calculator 29 receives as its input an output status Os of the rotating machine 1, where the output status Os of the rotating machine 1 is representative of a detection value of the electric current detector 24, a detection value of the rotation angle detector 28, an output instruction(s) of the electrical power conversion apparatus 21, a switching frequency, and so forth. As for the calculation of the copper loss, the copper loss is calculated from winding resistance characteristics having been held in advance in the rotating machine losses calculator 29, and also from a detection value of the electric current detector 24 or an electric current instruction value of the electrical power conversion apparatus. In addition, the copper loss may be calculated in such a manner that copper loss characteristics with respect to output operating points each are held in advance in the rotating machine losses calculator 29, and that the copper loss is calculated in accordance with a rotating machine's output having been calculated from an output status Os of the rotating machine. The iron loss is calculated from electric resistance characteristics having been held in advance in the rotating machine losses calculator 29, and also from the output status Os. Moreover, the iron loss may be calculated in such a manner that iron loss characteristics with respect to output operating points each are held in advance in the rotating machine losses calculator 29, and that the iron loss is calculated in accordance with a rotating machine's output having been calculated from an output status Os of the rotating machine.

FIG. 4 is a block diagram illustrating a configuration of the cooling-device state estimation device 30. As illustrated in FIG. 4, the cooling-device state estimation device 30 includes: a temperature detection-value holding device 32 for holding a temperature detection value Td at past-time; a temperature detection-value estimation device 33 for estimating a temperature detection value at current-time in accordance with the temperature detection value Td at past-time being held, and with a rotating machine's losses calculation value Rlc; an addition-subtraction calculator 34 for calculating a difference value between an aforementioned estimation value of a temperature detection value Td at current-time by way of the temperature detector 25 and a temperature detection value Td, i.e., a detected value of temperature by means of the temperature detector 25; and a cooling-state distinguishing device 35 for distinguishing a state of a cooling device from the difference value between the aforementioned estimation value of a temperature detection value at current-time and the temperature detection value Td by means of the temperature detector 25.

In the temperature detection-value estimation device 33 of FIG. 4, a correlation between a temperature detection value Td by means of the temperature detector 25 and losses of the rotating machine 1 is stored in advance, and so, the temperature detection-value estimation device estimates a temperature detection value Td at current-time ought to be detected, by using a temperature detection value Td at past-time held in the temperature detection-value holding device 32, a rotating machine's losses calculation value Rlc having been calculated by the rotating machine losses calculator 29, and the aforementioned correlation. As for a temperature detection value at current-time ought to be detected, the temperature detection value at current-time designates an estimation temperature at a detection position and in a detection time, where the temperature detector 25 performs the temperature detection. It should be noted that, because the aforementioned correlation is a correlation at the time when the cooling device 27 is in a normal state, the temperature detection value at current-time ought to be detected also estimates a temperature detection value in a normal state of the cooling device.

A correlation between a temperature detection value Td and a rotating machine's loss(es) is approximated by a lag or delay element of a zeroth order or more. If it is aimed as an object to take on temperature estimation in steady state operations in which a time-based or temporal element(s) may not be required for the consideration, the temperature estimation may be performed as temperature estimation by the approximation of a zeroth order (approximation only by thermal resistance), so that a processing load in the control device 23 can be reduced. In addition, if output variation of the electrical power conversion apparatus 21 is large so that it is necessary to consider a time-based or temporal element(s), it is desirable to perform temperature estimation by the approximation including a lag or delay element of a first order or more (approximation by thermal resistance and thermal capacitance). The correlation can be approximated in a higher degree of accuracy in accordance with the order which is made higher; however, the order should be suitably selected because the processing load in the control device 23 is to be increased accordingly.

The cooling-state distinguishing device 35 compares a difference value described above with a threshold value having been held in the cooling-state distinguishing device in advance, so that, when the difference value described above exceeds the threshold value, cooling device's abnormality is outputted as cooling-device state information Csi. The threshold value should be determined larger than a difference value between a temperature detection value Td and a temperature detection estimation value, in a case in which the cooling device 27 is normal. In the temperature estimation, temperature variation of cooling water cannot be considered, and so, temperature variation components of the cooling water are superimposed on the difference value described above. Here, in a case in which the losses caused by the rotating machine 1 are low, a temperature of cooling water becomes low, and, because the losses are proportional to an output of the rotating machine 1, temperature variation components in a difference value are small at a time when the output of the rotating machine 1 is low. Therefore, the threshold value can be set smaller than that of a case in which the output of the rotating machine 1 is high. When the threshold value is set smaller, the cooling state can be promptly distinguished, and thus, the accuracy of estimating the temperature is enhanced. In addition, the cooling-state distinguishing device 35 holds such a threshold value in a plurality of threshold values, whereby a state of the cooling device 27 can be distinguished in a finer manner, so that the accuracy of estimating a temperature(s) of the rotating machine 1 is enhanced.

FIG. 5 is a block diagram illustrating a configuration of the rotating machine temperature calculation device 31. As illustrated in FIG. 5, the rotating machine temperature calculation device 31 includes: a temperature rise characteristics selector 36 receiving as its input cooling-device state information Csi, for selecting temperature rise characteristics of the rotating machine 1 in accordance with a state of the cooling device 27; and a temperature calculator 37 receiving as its inputs the temperature rise characteristics described above, a rotating machine's losses calculation value Rlc and a temperature detection value Td, for calculating a rotating machine's temperature Rtc.

The temperature rise characteristics selector 36 records in advance a correlation of a temperature difference between a temperature of the temperature detector 25 and that at a predetermined position of the rotating machine 1 having been defined in advance with respect to a rotating machine's loss(es) for every one of states of a cooling device of the rotating machine, so that, in accordance with cooling-device state information Csi outputted from the cooling-device state estimation device 30, the temperature rise characteristics selector selects an appropriate correlation and outputs it. A correlation of the temperature difference between the temperature of the temperature detector 25 and that at a predetermined position of the rotating machine 1 having been defined in advance with respect to the rotating machine's loss(es) is approximated by a lag or delay element of a zeroth order or more because of similar reasons to the correlation between a temperature detection value Td and a rotating machine's loss(es) described above.

The temperature calculator 37 receives, as its inputs, temperature characteristics outputted from the temperature rise characteristics selector 36, a rotating machine's losses calculation value Rlc and temperature detection value Td, and calculates a temperature Rtc at a predetermined position of the rotating machine 1 having been defined in advance. The predetermined position of the rotating machine 1 having been defined in advance is not necessarily limited to that of the permanent magnet(s) 6, but the winding(s) 9, the shaft 7 and/or the like may also be suitable for. When a permanent magnet's temperature is calculated, a protective operation to the rotating machine is carried out by using a calculation value of permanent magnet's temperature, whereby irreversible demagnetization of the permanent magnet(s) 6 can be prevented. When a winding's temperature is calculated, a protective operation to the rotating machine is carried out by using a calculation value of winding's temperature, whereby burning of the winding(s) 9 can be prevented. In addition, when a shaft's temperature is calculated, a protective operation to the rotating machine is carried out by using a calculation value of shaft's temperature, whereby the degradation in grease of bearings supporting the shaft 7 can be prevented. Moreover, such a predetermined position of the rotating machine 1 having been defined in advance may also be defined at a plurality of positions, and so, by carrying out a protective operation to the rotating machine using temperature calculation-values Rtc at the plurality of positions of the rotating machine 1, it becomes possible to prevent a whole category of failures of the rotating machine 1 due to those failures to be brought about because of a high temperature state.

As described above, in the electrical power conversion apparatus 21 according to Embodiment 1, the estimation on a state of a cooling device is carried out by using a correlation by a lag or delay element of a zeroth order or more, whereby, while suppressing a processing load of the control device 23, a state of the cooling device can be estimated according to the estimation which follows up accurately also with respect to output changes in terms of time.

In addition, in accordance with a state of the cooling device having been estimated, suitably selected is a correlation of a temperature difference between a temperature by the temperature sensor 10 and that at a predetermined position of the rotating machine 1 having been defined in advance with respect to a rotating machine's loss(es), so that a rotating machine's temperature is estimated. According to this arrangement, a temperature at the predetermined position of the rotating machine 1 having been defined in advance can be accurately estimated also in accordance with any one of states of the cooling device.

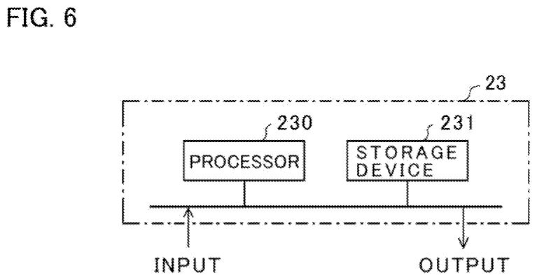

It should be noted that, as an example of hardware is illustrated in FIG. 6, the control device 23 in the electrical power conversion apparatus 21 is constituted of a processor 230 and a storage device 231, for example. The storage device 231 is provided with a volatile storage device of a random access memory (RAM) or the like, and with a nonvolatile auxiliary storage device of a flash memory or the like, for example. In addition, in place of the flash memory, an auxiliary storage device of a hard disk may be provided with. The processor 230 executes a program(s) inputted from the storage device 231. In this case, the program(s) is inputted into the processor 230 from the auxiliary storage device by way of the volatile storage device. Moreover, the processor 230 may output its data of a calculated result(s) or the like into the volatile storage device of the storage device 231, or may store the data into the auxiliary storage device by way of the volatile storage device.

In the present disclosure of the application concerned, exemplary embodiments are described; however, various features, aspects and functions described in an embodiment(s) are not necessarily limited to the applications of a specific embodiment(s), but are applicable in an embodiment(s) solely or in various combinations.

Therefore, limitless modification examples not being exemplified can be presumed without departing from the scope of the technologies disclosed in Specification of the disclosure of the application concerned. For example, there exists a modification example which is included as a case in which at least one constituent element is modified, added to or eliminated from a constituent element(s) of another embodiment.

What is claimed is:

1. An electrical power conversion apparatus, comprising:
a control device for controlling a rotating machine cooled by a cooling device; and
a temperature detector for detecting a temperature of the rotating machine, wherein
the control device comprises:
a rotating machine losses calculator for calculating loss of the rotating machine by using an output status of the rotating machine;
a cooling-device state estimation device for estimating a state of the cooling device from a temperature detection value of the temperature detector; and
a rotating machine temperature calculation device for estimating a temperature at a position of the rotating machine determined in advance, on a basis of a rotating machine's losses calculation value of the rotating machine losses calculator and on that of an estimation result of the cooling-device state estimation device.

2. The electrical power conversion apparatus as set forth in claim 1, wherein an output status of the rotating machine is calculated by using at least any one of a detection value of an electric current detector for measuring an electric current flowing through the rotating machine, a detection value of a rotation angle detector for detecting a rotation angle of the rotating machine, and an output instruction of the electrical power conversion apparatus.

3. The electrical power conversion apparatus as set forth in claim 1, wherein
the cooling-device state estimation device includes:
a temperature detection-value holding device for holding a temperature detection value detected by the temperature detector;
a temperature detection-value estimation device for estimating a temperature at current-time by using a temperature detection value at past-time held in the temperature detection-value holding device and a losses calculation value of the rotating machine from the rotating machine losses calculator; and
a cooling-state distinguishing device for determining a state of the cooling device in accordance with a difference value between a temperature detection estimation value outputted from the temperature detection-value estimation device and a temperature detection value detected by the temperature detector.

4. The electrical power conversion apparatus as set forth in claim 3, wherein the temperature detection-value estimation device approximates, on a basis of a losses calculation value of the rotating machine from the rotating machine losses calculator, a correlation between a temperature detection value at past-time held in the temperature detection-value holding device and a temperature detection value of the temperature detector by a delay element of a zeroth order or more.

5. The electrical power conversion apparatus as set forth in claim 3, wherein the cooling-state distinguishing device compares a difference value between a temperature detection estimation value outputted from the temperature detection-value estimation device and a temperature detection value of the temperature detector with at least one predetermined threshold value or more of it, and distinguishes whether the cooling device is in a normal state or in an abnormal state of cooling.

6. The electrical power conversion apparatus as set forth in claim 5, wherein a threshold value of the cooling-state distinguishing device changes in accordance with an output status of the rotating machine.

7. The electrical power conversion apparatus as set forth in claim 6, wherein a threshold value of the cooling-state distinguishing device is set at a value smaller than that determined in advance when an output of the rotating machine is lower than an output thereof determined in advance.

8. The electrical power conversion apparatus as set forth in claim 1, wherein
the rotating machine temperature calculation device includes:
a temperature rise characteristics selector for selecting, in accordance with a state of the cooling device from the cooling-device state estimation device, a correlation of a temperature difference between a temperature detection value of the temperature detector and a temperature at a position of the rotating machine determined in advance, with respect to a losses calculation value of the rotating machine from the rotating machine losses calculator; and
a temperature calculator for estimating a temperature at a respective position of the rotating machine, on a basis of a rotating machine's losses calculation value of the rotating machine losses calculator, on that of a temperature detection value of the temperature detector and on that of a state of the cooling device from the cooling-device state estimation device, and wherein
the temperature calculator of the rotating machine temperature calculation device estimates a temperature at a position of the rotating machine determined in advance by using a correlation where the temperature rise characteristics selector selects from the temperature difference therebetween with respect to a losses calculation value of the rotating machine from the rotating machine losses calculator, the losses calculation value of the rotating machine, and a temperature detection value of the temperature detector.

9. The electrical power conversion apparatus as set forth in claim 2, wherein
the rotating machine temperature calculation device includes:
a temperature rise characteristics selector for selecting, in accordance with a state of the cooling device from the cooling-device state estimation device, a correlation of a temperature difference between a temperature detection value of the temperature detector and a temperature at a position of the rotating machine determined in advance, with respect to a losses calculation value of the rotating machine from the rotating machine losses calculator; and
a temperature calculator for estimating a temperature at a respective position of the rotating machine, on a basis of a rotating machine's losses calculation value of the rotating machine losses calculator, on that of a temperature detection value of the temperature detector and on that of a state of the cooling device from the cooling-device state estimation device, and wherein
the temperature calculator of the rotating machine temperature calculation device estimates a temperature at a position of the rotating machine determined in advance by using a correlation where the temperature rise characteristics selector selects from the temperature difference therebetween with respect to a losses calculation value of the rotating machine from the rotating machine losses calculator, the losses calculation value of the rotating machine, and a temperature detection value of the temperature detector.

10. The electrical power conversion apparatus as set forth in claim 1, wherein a position of the rotating machine determined in advance at which a temperature is estimated by the rotating machine temperature calculation device includes a magnet of the rotating machine.

11. The electrical power conversion apparatus as set forth in claim 1, wherein a position of the rotating machine determined in advance at which a temperature is estimated in the rotating machine temperature calculation device includes a winding in a stator of the rotating machine.

12. The electrical power conversion apparatus as set forth in claim 1, wherein a position of the rotating machine determined in advance at which a temperature is estimated in the rotating machine temperature calculation device includes a shaft in a rotor of the rotating machine.

13. The electrical power conversion apparatus as set forth in claim 1, wherein a position of the rotating machine determined in advance at which a temperature is estimated in the rotating machine temperature calculation device includes a plurality of positions of the rotating machine.

14. The electrical power conversion apparatus as set forth in claim 1, wherein the temperature detector detects a temperature at a winding of the rotating machine.

15. The electrical power conversion apparatus as set forth in claim 1, wherein the temperature detector detects a temperature at a magnet in a rotor of the rotating machine.

16. The electrical power conversion apparatus as set forth in claim 1, wherein the temperature detector detects a temperature at an electrical steel sheet of the rotating machine.

17. The electrical power conversion apparatus as set forth in claim 1, wherein the temperature detector detects a temperature at a shaft of the rotating machine.

18. The electrical power conversion apparatus as set forth in claim 1, wherein the temperature detector detects a temperature at a housing of the rotating machine.

19. The electrical power conversion apparatus as set forth in claim 1, wherein the temperature detector detects temperatures at a plurality of positions of the rotating machine.
